(19) United States
(12) Patent Application Publication
(10) Pub. No.: US 2011/0067376 A1
(43) Pub. Date: Mar. 24, 2011

(54) PLASMA-BASED WASTE-TO-ENERGY TECHNIQUES

(75) Inventors: Alan Tompkins, Mt. Juliet, TN (US); Jim Kingzett, Gardnerville, NV (US)

(73) Assignee: GEOVADA, LLC, Gardnerville, NV (US)

(21) Appl. No.: 12/759,636

(22) Filed: Apr. 13, 2010

Related U.S. Application Data
(63) Continuation-in-part of application No. 12/725,410, filed on Mar. 16, 2010.
(60) Provisional application No. 61/160,456, filed on Mar. 16, 2009.
(60) Provisional application No. 61/168,816, filed on Apr. 13, 2009.
(60) Provisional application No. 61/171,527, filed on Apr. 22, 2009.
(60) Provisional application No. 61/171,538, filed on Apr. 22, 2009.
(60) Provisional application No. 61/171,542, filed on Apr. 22, 2009.
(60) Provisional application No. 61/187,581, filed on Jun. 16, 2009.
(60) Provisional application No. 61/187,586, filed on Jun. 16, 2009.

(51) Int. Cl. F02C 3/28

(52) U.S. Cl. 60/39.12

(57) ABSTRACT

Plasma-Based Waste-to-Energy (PBWTE) methods/systems, including plasma-assisted gasification systems, are described that can be integrated into a single system which when fed a steam of municipal solid waste, discarded tires, or electronic wastes, organic or inorganic, which have been shredded to a uniform size produces a synthesis gas (syngas) and a molten slag, and/or electricity. The systems can be mobile, for example, implemented on a vehicle.

### RELATED APPLICATIONS

This is a continuation-in-part of U.S. patent application Ser. No. 12/725,410, filed 16 Mar. 2010, and entitled “Plasma-Assisted E-Waste Conversion Techniques,” which claims priority to U.S. Provisional Patent Application No. 61/160,456, filed 16 Mar. 2009, and entitled “Plasma-Assisted E-Waste Conversion Techniques,” the entire contents of both of which applications are incorporated herein by reference.

This application also claims priority to the following applications: U.S. Provisional Patent Application Ser. No. 61/168,816, filed 13 Apr. 2009, and entitled “Plasma Assisted E-Waste Conversion Techniques”; U.S. Provisional Patent Application Ser. No. 61/171,527, filed 22 Apr. 2009, and entitled “Cooling Data Center Servers with Dry Ice”; U.S. Provisional Patent Application Ser. No. 61/171,538, filed 22 Apr. 2009, and entitled “Geothermal Electrical Power Plants”; U.S. Provisional Patent Application Ser. No. 61/171,542, filed 22 Apr. 2009, and entitled “Plasma Assisted Gasification (“PAG”) E-Waste Conversion Techniques”; U.S. Provisional Patent Application Ser. No. 61/187,581, filed 16 Jun. 2009, and entitled “Within Grid Methods and Systems”; and, U.S. Provisional Patent Application Ser. No. 61/187,586, filed 16 Jun. 2009, and entitled “Green Cloud Computing Methods and Systems”: the entire contents of all of which applications are incorporated herein by reference.

### BACKGROUND

Disposal of waste is an increasingly serious problem, as evidenced by the ever-growing amount of often-toxic materials dumped into the ocean, buried in landfills, and shipped over seas to third-world countries. So called e-waste, including thrown out or obsolete computer parts and components, is an increasingly significant component of waste. Such e-waste is projected to increase in volume as consumer demand for computers, mobile phones, and personal digital assistants increases.

### SUMMARY

Aspects and embodiments of the of the present disclosure address problems previously described by providing systems and methods of processing waste, including e-waste, to reduce the volume of the waste while also producing energy.

Aspects of the present disclosure are directed to plasma-based waste-to-energy (PBWTE) systems.

An exemplary embodiment can include a plasma-based waste-to-energy (PBWTE) system including a shredder; a primary reactor configured to receive shredded waste (e.g., e-waster or tires) from the shredder and incinerate the waste by application of plasma and producing syngas; a primary heat exchanger connected to the primary reactor and configured to receive heat from the primary reactor and transfer heat to a fluidic circuit for heat exchange; a gas turbine for producing electricity from syngas; a syngas scrubber configured to receive syngas produced by the primary reactor; and a system controller configured to control the primary reactor.

The controller can be programmed to control the electrical output of the gas turbine to match the needs of a facility electrically connected to the system.

The system can include a secondary reactor configured to burn syngas or waste (e-waste) combustion products.

The system can further include a secondary heat exchanger configured to extract heat from the secondary reactor.

The system can further include a vehicle, and the primary reactor can be disposed on or in the vehicle.

Further aspects of the present disclosure are directed to plasma-based methods of recovering energy from waste.

An exemplary embodiment of a PBWTE method can include introducing waste into a plasma reactor; incinerating the e-waste by a plasma process; and utilizing energy from the plasma process.

Utilizing energy from the plasma process can include generating heat.

Utilizing energy from the plasma process can include generating electricity.

Utilizing energy from the plasma process can include generating syngas, e.g., hydrogen gas, etc.

The method can include using a Fischer-Tropsch process to produce liquid hydrocarbon.

The liquid hydrocarbon can be wax or other liquid hydrocarbons.

Syngas and/or heat can be fed into one or more bioreactors that contain trays of genetically engineered microbes.

The syngas gas can be converted to ethanol, or other alcohols.

The syngas can be converted to acetic acid.

The waste can be e-waster including computer components and the like.

The method can include distributing the electricity to a local electricity grid.

The method can include distributing the electricity to a data center.

The method can include using the syngas to fuel a turbine that has an integrated generator.

The method can include using the syngas to power a reciprocating diesel or gas engine, e.g., that drives a generator.

The method can include using hot water and/or steam generated by the reactor during a cooling process to power a turbine that is configured to drive a generator.

The method can include using hot water and/or steam generated by cooling inorganic slag produced by the reactor as the slag exits the bottom of the reactor.

The method can include placing the plasma reactor and/or other plasma system components on a vehicle.

It will be appreciated that the foregoing embodiments and aspects can be combined or arranged in any practical combination.

Other features of embodiments of the present disclosure will be apparent from the description, the drawings, and the claims herein.

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 depicts a box diagram representing system/method, in accordance with exemplary embodiments of the present disclosure;

FIG. 2 depicts a box diagram representing a system/method including a bioreactor, in accordance with alternate embodiments of the present disclosure;

FIG. 3 depicts a box diagram of another embodiment of the present disclosure; and

FIG. 4 is a box diagram representing a method in accordance with exemplary embodiments of the present disclosure.

While certain embodiments are depicted in the drawings, one skilled in the art will appreciate that the embodiments depicted are illustrative and that variations of those shown, as well as other embodiments described herein, may be envisioned and practiced within the scope of the present disclosure. Accordingly, the drawings and detailed description are to be regarded as illustrative in nature and not as restrictive.

### DETAILED DESCRIPTION

Plasma-based waste-to-energy systems/methods (PBWTE), sometime referred to as Plasma Assisted Gasification (PAG), according to the present disclosure can be composed of several components (which may be/are) currently commercially available and operating in various forms and functions, as will be described.

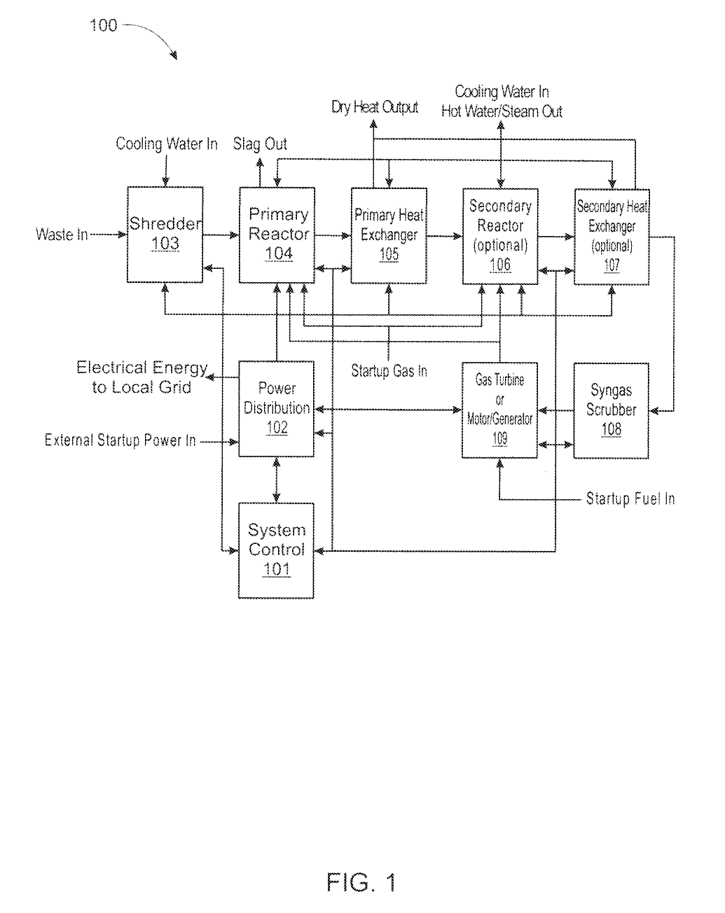

FIG. 1 depicts a box diagram representing system/method 100 in accordance with exemplary embodiments of the present disclosure.

As shown in FIG. 1, in a Plasma-Based Waste-to-Energy (PBWTE) facility/system 100 according to the present disclosure, these components are integrated into a single system which when fed a steam of municipal solid waste, discarded tires, or electronic wastes, organic or inorganic, which have been shredded, e.g., ideally to a uniform size (3), produces a synthesis gas (syngas) and a molten slag (4), and/or electricity. In the plasma arc phase (4) (6) the wastes are broken down by intense heat, e.g., 8,000 to 15,000° C., through atomic dissociation thus passing from the solid to the gas phase. The speed of this reaction is such that no toxic dioxins or furans are formed. System 100 (and other according to the present disclosure) can utilize suitable plasma-assisted gasification techniques, e.g., as described herein and/or described in U.S. Patent Application Publication No. US 2003/0171635, published 11 Sep. 2003, and entitled “Method for Treatment of Hazardous Fluid Organic Waste Materials,” the entire contents of which are incorporated herein by reference. Exemplary embodiments of the present disclosure can include or provide recovering energy from waste, such as ash from a coal-fired power plant, shredded automobile tires, and other waste products. Furthermore, for embodiments utilizing ash from coal-fired power plants, the operation of the power plant can be tailored to reduce environmental impact, e.g., discharge water can be purified to meet EPA and other standards, and/or the power plant air emission can be reduced or eliminated.

Continuing with the description of FIG. 1, syngas can then cooled through heat exchangers 105 and 107, which produce steam 104-107. The steam can then be used to power steam turbine-driven electrical generators (not shown). Once cooled, the syngas passes through a gas scrubber to remove particulate matter. The syngas may them be used as a fuel to power gas turbine-driven electrical generators 109 or an internal combustion engine which powers a generator 109. Exhaust gasses from either the turbine or internal combustion engine are returned to either the primary 104 or secondary 106 reaction chamber where they are reprocessed and added to the generated syngas.

In exemplary embodiments, from 20 to 35% of the electrical energy generated 109 can be used to run the PBWTE system and the remaining electrical energy may be sold to local power companies 102 or used onsite as needed. In most developed nations, power companies must purchase all electrical energy produced by environmentally friendly means and they must pay a minimum price equal to or greater than the current local wholesale price per kilowatt hour. Depending on waste composition, each ton of waste can, or may be expected to, produce approximately one megawatt of electrical energy. Other outputs may of course be realized as a function of the energy content of the incoming wastes. Exemplary embodiments may also use power on-site (“within the fence”) or within the project, without selling or distributing the power to a utility/power grid.

Although not shown in FIG. 1, it should be noted that an alternate process (or processes) may be used, in which the syngas (produced by the primary reactor) is fed into a series of (one or more) bioreactors that contain trays of genetically engineered material or microbes (e.g., algae or bacteria) which convert the incoming gas to either ethanol or acetic acid or a combination of both, depending on the selection of microbes.

Such a bioreactor process also produces carbon dioxide (CO₂) as an off-gas. A portion of this CO₂ can be fed back into the reaction chamber 104, 106, e.g., to prevent the formation of nitric oxides (N₂O), and any remaining CO₂, may be captured and fed into algae beds as a growth stimulant where the algae is commercially produced as a base for BioFuels, or may be compressed to form dry ice and sold to transportation companies. H2 can be produced as a component of the syngas, and such may be used as desired, e.g., for a H2 distribution network for automobiles powered by hydrogen/oxygen based fuel cells. In exemplary embodiments, waste heat from a PBWTE process can be ported/sent to a project/district heating loop, and possibly along with other project waste heat, can be used for a variety of heating and cooling needs. For example, CO2 can be extracted to form dry ice for cooling needs, and CO2 and heat can be extracted and used for algae production, such as used to make bio-diesel or other biofuels.

Should one elect to produce acetic acid, about one half ton of glacial-grade acetic acid can be produced. If the production of ethanol is the choice, about 128 gallons will be produced from one ton of waste, again, this is dependant on the type of waste processed. The ethanol may be sold as a motor-fuel additive or it may be retained and used as a fuel for gas-turbine or internal combustion powered electrical generators.

Virtually every pound of waste entering the system produces a salable product in one form or another. Even the inorganic material forms a vitrified slag which exits at the bottom of the primary reaction chamber 104, may be sold as a high quality, nonleachable, construction material. No pollutants, either solid or gas, leave the system as air or surface releases.

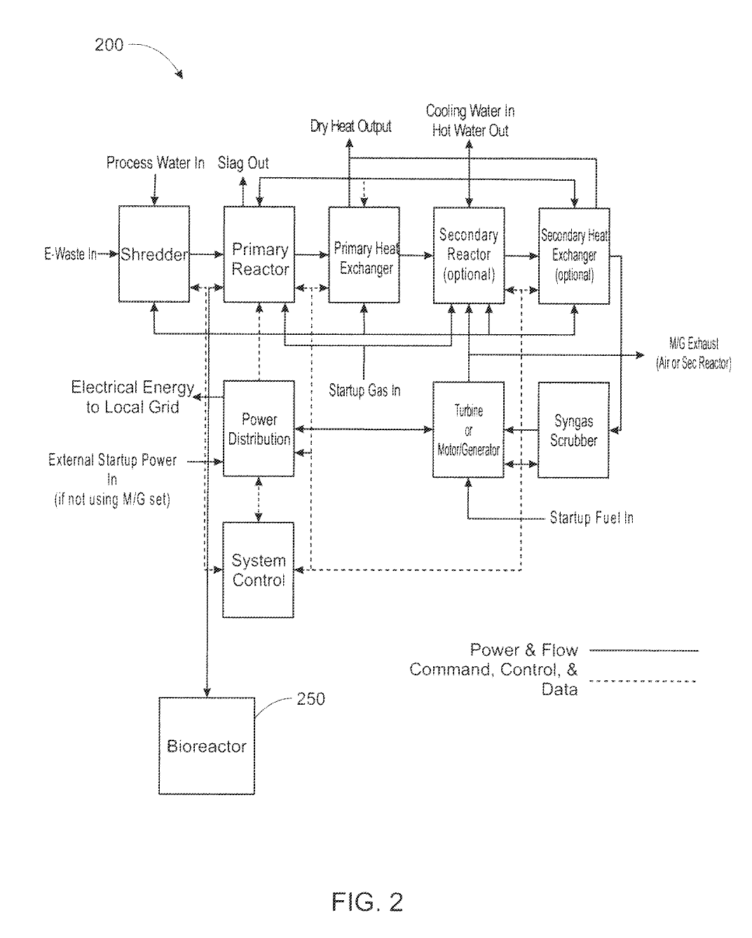

FIG. 2 depicts a box diagram representing a system/method 200 similar to that of FIG. 1 with the addition of a bioreactor 250, in accordance with alternate embodiments of the present disclosure.

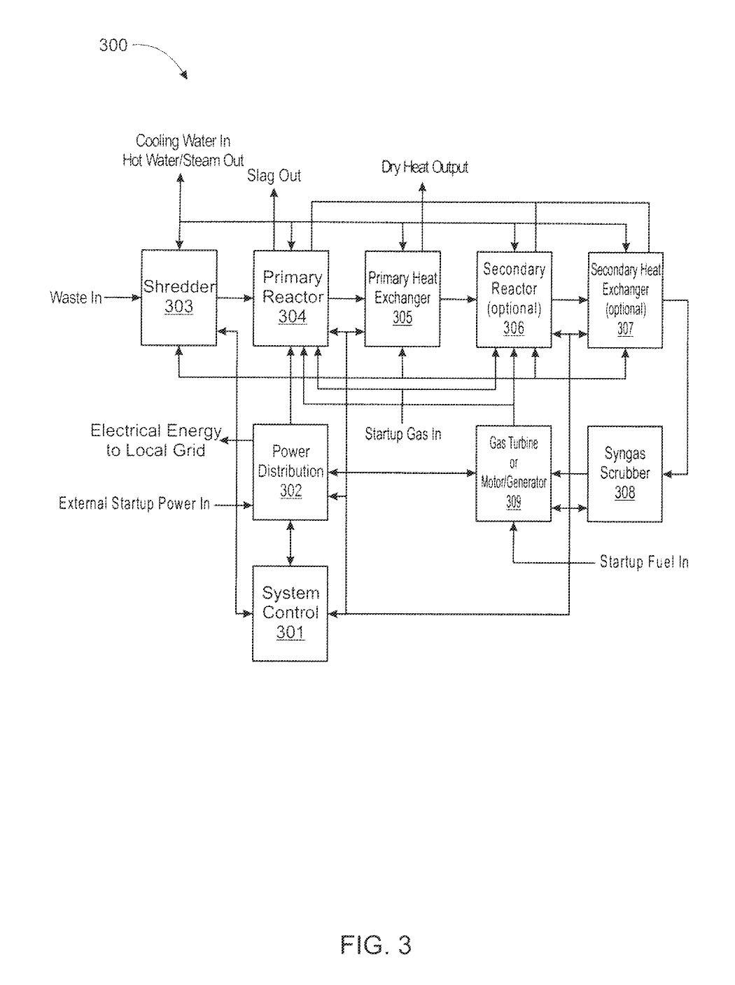

FIG. 3 depicts another embodiment 300 of the present disclosure. Embodiment 300 is similar to embodiment 100 of FIG. 1, and includes a system controller 301, a power distribution system 302, a shredder 303, a primary reactor 304, and a primary heat exchanger 305. An optional secondary plasma reactor 306 and optional secondary heat exchanger 307 are also shown. System 300 can include a gas turbine or motor/generator 309 as shown. A syngas scrubber 307 may be present as shown. The heating of water can be accomplished by a heat exchange system (not shown) as one or both reactors generate heat or from slag produced as a byproduct of the plasma incineration process.

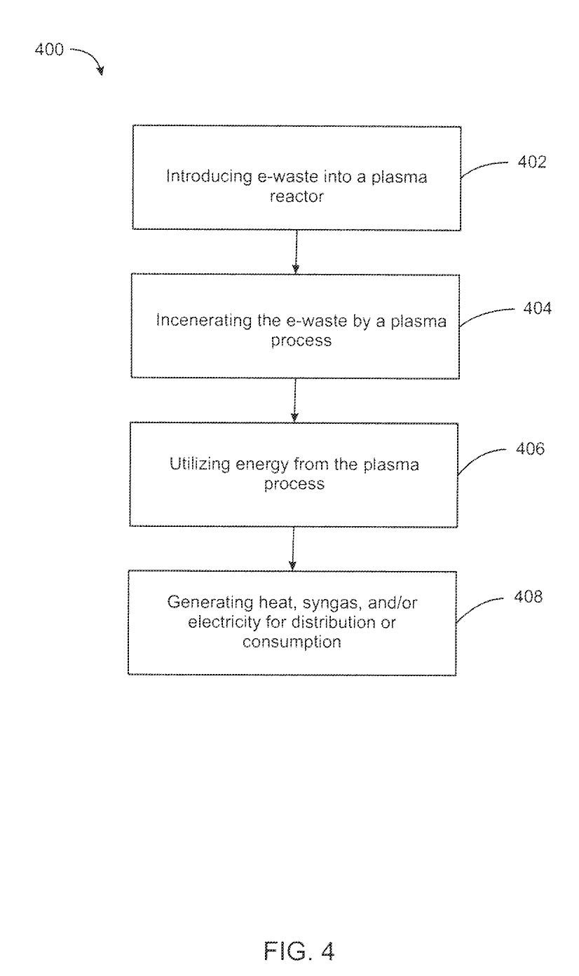

FIG. 4 depicts a box diagram representing a general method 400, in accordance with exemplary embodiments of the present disclosure. As shown, method 400 can include introducing e-waste (or other waste) into a plasma reactor, as described at 402. The waste can be incinerated by the plasma, as described at 404. Energy, e.g., in the form of heat and/or syngas, can be utilized as a result of the plasma process, as described at 406. Heat, syngas, e.g., hydrogen, and/or electricity can as a result be distributed, e.g., to a local grid or data center, or consumed, e.g., on site.

As shown in FIGS. 1-3, an output of electricity may be produced by the systems/methods 100, 200, and 300. Such can be used as desired. In exemplary embodiments, system/methods 100, 200, and/or 300 are employed at the site of a data center (“DC”) (or other infrastructure requiring energy) for power. Accordingly, the carbon footprint of the DC (and/or other infrastructure, including a community) can be minimized or put to zero by implementation of embodiments of the present disclosure.

Because a PBWTE system may be located close to, proximate, or at a DC, such a PBWTE system may be economically superior/advantageous to other power sources. The concept of Distributed Energy of Generation is being encouraged as a way of (means for) using energy locally where such can be accomplished without utilizing the limited transmission capacity of energy grids.

Optimally a PBWTE system will get many times more energy from 500 tons of e-waste than a coal fired plant gets from 5,000 tons of coal. A PBWTE system that burns only coal is several hundred percent more efficient that a boiler-based coal fired plant. It's for this reason that PBWTE systems according to the present disclosure can take both bed and fly ash from power plant operations and extract a significant amount of energy from the ash by way of conversion to energy in the PBWTE process.

In exemplary embodiments, an e-waste PBWTE system, besides producing electrical energy or ethanol as primary products, can also produce a number of valuable byproducts such as heat for heating and cooling buildings, facilitating plant growth in contained environment agricultural projects including growing algae for biofuels and many other uses. Data center waste heat can also be extracted and combined with PBWTE waste heat to enhance such previously-described uses.

Electronic products, e.g., computer parts and the like, become e-waste following their manufacturing and utilization phases when such products are discarded and disposed at the termination of their lifecycle. Additionally, a significant amount of waste is generated during the manufacturing phase of electronic products. A greater amount of waste created is can be created by many of the manufacturing processes than the total volume of discarded e-waste.

### Exemplary Embodiments—Electricity Generation:

Exemplary embodiments of the present disclosure can include one or more of five techniques or ways to generate electrical energy in conjunction with a plasma-based waste-to-energy plant/system, e.g., as shown and described for FIGS. 1-3. In all cases, the syngas is preferably cleaned up (or, “scrubbed”) after leaving the plasma reaction chamber (sometimes called a cupola). These techniques are not necessarily all-inclusive and there may be other ways to generate electrical energy.

After cleaning up (scrubbing) the syngas produced by a plasma primary reactor (primary or secondary) the following may occur:
1. Use the syngas to fuel a turbine which has an integrated generator;
2. Use the syngas to power a reciprocating diesel or gas engine which drives a generator;
3. Process the syngas through a bioreactor which contains genetically engineered microbes which converts the syngas to ethanol; then use the ethanol as a fuel for a turbine or reciprocating engine;
4. Use the hot water and steam generated in the reactor cooling process or in process of cooling the inorganic slag as it exits the bottom of the reactor to power a turbine which drives a generator (both of these hot water sources may result, regardless of what is done with the syngas); and/or
5. Use the syngas via the Fischer-Tropsch to produce a fuel, e.g., that can then be used to drive a generator as describe in 2, above.

In exemplary embodiments, process/technique 4 is preferably used unless it makes more economic sense to use the hot water in the algae beds, which may be the case for some applications.

In items 1, 2, and 3, the exhaust gasses from the turbines and/or reciprocating engines can be returned to the reaction chamber or the syngas scrubber for reprocessing. Accordingly, by recycling the exhaust gasses, the waste going into the input can be essentially supplemented so as to increase the overall input fuel supply.

Four things can be considered to determine energy output; energy in feedstock, condition of feedstock when entering the reaction chamber, feed rate, and chamber temp. All of these are (can be) closely linked.

Energy output can vary because there are many variables in a complete system that must be factored in. On average, one can assume about 1 MWh/t-MSW gross with a net (for sale to the local grid) between 650 and 750 kWh. A waste shredder can be considered/factored in when estimating the net energy output as its energy requirement can otherwise be underestimated and it can draw very significant current.

### Exemplary Embodiments—Fischer-Tropsch Process:

In exemplary embodiments, a Fischer-Tropsch process can be used as mentioned above.

The Fischer-Tropsch process (or Fischer-Tropsch Synthesis) is a catalyzed chemical reaction in which synthesis gas, a mixture of carbon monoxide and hydrogen, is converted into liquid hydrocarbons of various forms. The most common catalysts are based on iron and cobalt, although nickel and ruthenium have also been used. The principal purpose of this process is to produce a synthetic petroleum substitute, typically from coal, natural gas or biomass, for use as synthetic lubrication oil or as synthetic fuel. This synthetic fuel can be used to run combustion engines, e.g., trucks, cars, and some aircraft engines.

The Fischer-Tropsch process involves a variety of competing chemical reactions, which lead to a series of desirable products and undesirable byproducts. The most important reactions are those resulting in the formation of alkanes. These can be described by chemical equations of the form: (2n+1)H2+nCO→CnH(2n+2)+nH2O, where ‘n’ is a positive integer. The simplest of these (n=1), results in formation of methane, which is generally considered an unwanted by-product (particularly when methane is the primary feedstock used to produce the synthesis gas). Process conditions and catalyst composition are usually chosen to favor higher order reactions (n>1) and thus minimize methane formation. Most of the alkanes produced tend to be straight-chained, although some branched alkanes are also formed. In addition to alkane formation, competing reactions result in the formation of alkenes, as well as alcohols and other oxygenated hydrocarbons. Usually, only relatively small quantities of these non-alkane products are formed, although catalysts favoring some of these products have been developed.

Another important reaction is the water gas shift reaction: H2O+CO→>H2+CO2

Although this reaction results in formation of unwanted CO2, it can be used to shift the H2:CO ratio of the incoming Synthesis gas. This is especially important for synthesis gas derived from coal, which tends to have a ratio of ˜0.7 compared to the ideal ratio of ˜2.

It should be noted that, according to published data on the current commercial implementations of the coal-based Fischer-Tropsch process, these plants can produce as much as 7 tons of CO2 per ton of liquid hydrocarbon products (excluding the reaction water product). This is due in part to the high energy demands required by the gasification process, and in part by the design of the process as implemented.

Combination of biomass gasification (BG) and Fischer-Tropsch (FT) synthesis is a possible route to produce renewable transportation fuels (biofuels).

A variety of catalysts can be used for the Fischer-Tropsch process, but the most common are the transition metals cobalt, iron, and ruthenium. Nickel can also be used, but tends to favor methane formation. Cobalt seems to be the most active catalyst, although iron also performs well and can be more suitable for low-hydrogen-content synthesis gases such as those derived from coal due to its promotion of the water-gas-shift reaction. In addition to the active metal the catalysts typically contain a number of promoters, including potassium and copper, as well as high-surface-area binders/supports such as silica, alumina, or zeolites.

Unlike the other metals used for this process (Co, Ni, Ru) which remain in the metallic state during synthesis, iron catalysts tend to form a number of chemical phases, including various iron oxides and iron carbides during the reaction. Control of these phase transformations can be important in maintaining catalytic activity and preventing breakdown of the catalyst particles.

The Fischer-Tropsch catalysts are notoriously sensitive to the presence of sulfur-containing compounds among other poisons. The sensitivity of the catalyst to sulfur is higher for cobalt-based catalysts than for their iron counterparts.

Cobalt catalysts are preferred for Fischer-Tropsch synthesis when the feedstock is natural gas due to the higher activity of the cobalt catalyst. Natural gas has a high hydrogen to carbon ratio, so the water-gas-shift is not needed for cobalt catalysts. Iron catalysts are preferred for lower quality feedstocks such as coal or biomass. While iron catalysts are also susceptible to sulfur poisoning from coal with high sulfur content, the lower cost of iron makes its use as a sacrificial catalyst at the front of a reactor bed economical. Also, as mentioned earlier, iron can catalyze the water-gas-shift to increase the hydrogen to carbon ratio to make the reaction more favorably selective.

The initial reactants (synthesis gases) used in the Fischer-Tropsch process are hydrogen gas (H2) and carbon monoxide (CO). These chemicals are usually produced by one of two methods:
1. The partial combustion of a hydrocarbon:

CnH(2n+2)+½ nO2→(n+1)H2+nCO
When n=1 (methane), the equation becomes 2CH4+O2→4H2+2CO
2. The gasification of coal, biomass, or natural gas:

CHx+H2O→(1+0.5x)H2+CO

The value of “x” depends on the type of fuel. For example, natural gas has a greater hydrogen content (x=5 to x=3) than coal (x>2).

The energy needed for this endothermic reaction is usually provided by the (exothermic) combustion of oxygen and the hydrocarbon source.

The mixture of carbon monoxide and hydrogen is called synthesis gas or syngas. The resulting hydrocarbon products are refined to produce the desired synthetic fuel.

The carbon dioxide and carbon monoxide can be generated by partial oxidation of coal and wood-based fuels. The utility of the process is primarily in its role in producing fluid hydrocarbons from a solid feedstock, such as coal or solid carbon-containing wastes of various types. Non-oxidative pyrolysis of the solid material produces syngas, which can be used directly as a fuel without being taken through Fischer-Tropsch transformations. If liquid petroleum-like fuel, lubricant, or wax is required, the Fischer-Tropsch process can be applied. Other suitable techniques for producing liquid hydrocarbon may be used, e.g., as disclosed in U.S. Pat. No. 4,659,743, U.S. Pat. No. 4,849,571, U.S. Pat. No. 5,104,902, U.S. Pat. No. 5,126,377, and U.S. Pat. No. 6,586,481; the entire contents of all of which are incorporated herein by reference.

Embodiments of the present disclosure can provide electricity or other energy (e.g., heat, useful gasses, etc.) off the local or regional/national electricity grid. Further, embodiments of the present disclosure, e.g., system 100 of FIG. 1, can include or be configured as a portable plasma reactor system on a vehicle for incineration of waste (e.g., e-waste or biological waste) at a facility, e.g., a hospital, with simultaneous or subsequent production of resulting syngas and/or electricity.

One skilled in the art will appreciate that embodiments and/or portions of embodiments of the present disclosure (e.g., control signals or commands) can be implemented in/with computer-readable storage media (e.g., hardware, software, firmware, or any combinations of such), and can be distributed and/or practiced over one or more communications networks.

Steps or operations (or portions of such) as described herein, including processing functions to derive, learn, or calculate formula and/or mathematical models utilized and/or produced by the embodiments of the present disclosure, can be processed by one or more suitable processors, e.g., central processing units (“CPUs) or other processor implementing suitable code/instructions in any suitable language (machine dependent on machine independent). Furthermore, embodiments of the present disclosure can be implemented as or include signals. For example, embodiments of the present disclosure can include wireless RF or infrared signals or electrical signals over a suitable medium such as optical fiber or other communication network for control of a PBWTE system/method.

While certain embodiments and/or aspects have been described herein, it will be understood by one skilled in the art that the methods, systems, and apparatus of the present disclosure may be embodied in other specific forms without departing from the spirit thereof. Accordingly, the embodiments described herein are to be considered in all respects as illustrative of the present disclosure and not restrictive.

What is claimed is:

1. A plasma-based waste-to-energy (PBWTE) system comprising:
a shredder;
a primary reactor configured to receive shredded waste from the shredder and incinerate the waste by application of plasma and producing syngas;
a primary heat exchanger connected to the primary reactor and configured to receive heat from the primary reactor and transfer heat to a fluidic circuit for heat exchange;
a gas turbine for producing electricity from syngas;
a syngas scrubber configured to receive syngas produced by the primary reactor; and
a system controller configured to control the primary reactor.

2. The system of claim 1, wherein the controller is programmed to control the electrical output of the gas turbine to match the needs of a facility electrically connected to the system.

3. The system of claim 1, further comprising a secondary reactor configured to burn syngas or e-waste combustion products.

4. The system of claim 3, further comprising a secondary heat exchanger configured to extract heat from the secondary reactor.

5. The system of claim 1, further comprising a vehicle, wherein the primary reactor is disposed on the vehicle.

6. A method of recovering energy from waste, the method comprising:
introducing waste into a plasma reactor;
incinerating the e-waste by a plasma process; and
utilizing energy from the plasma process.

7. The method of claim 6, wherein utilizing energy from the plasma process comprises generating heat.

8. The method of claim 6, wherein utilizing energy from the plasma process comprises generating electricity.

9. The method of claim 6, wherein utilizing energy from the plasma process comprises generating syngas.

10. The method of claim 9, further comprising a Fischer-Tropsch process to produce liquid hydrocarbon.

11. The method of claim 10, wherein the liquid hydrocarbon comprises wax.

12. The method of claim 9, further comprising feeding syngas into one or more bioreactors that contain trays of genetically engineered microbes.

13. The method of claim 12, wherein the syngas gas is converted to ethanol.

14. The method of claim 12, wherein the syngas is converted to acetic acid.

15. The method of claim 6, wherein the waste comprises e-waster including computer components.

16. The method of claim 8, further comprising distributing the electricity to a local electricity grid.

17. The method of claim 8, further comprising distributing the electricity to a data center.

18. The method of claim 9, further comprising using the syngas to fuel a turbine that has an integrated generator.

19. The method of claim 9, further comprising using the syngas to power a reciprocating diesel or gas engine that drives a generator.

20. The method of claim 6, further comprising using hot water and/or steam generated by the reactor during a cooling process to power a turbine that is configured to drive a generator.

21. The method of claim 6, further comprising using hot water and/or steam generated by cooling inorganic slag produced by the reactor as the slag exits the bottom of the reactor.

22. The method of claim 6, further comprising placing the plasma reactor on a vehicle.
